(19) United States
(12) Patent Application Publication
(10) Pub. No.: US 2007/0289467 A1
(43) Pub. Date: Dec. 20, 2007

(54) Direct printing lithography system and method

(75) Inventors: Hsueh-Chung Chen, Yonghe City (TW); Ding-Chung Lu, Hsin-Chu City (TW); Su-Chen Fan, Yonghe City (TW)

Correspondence Address: THOMAS, KAYDEN, HORSTEMEYER & RISLEY LLP, 600 GALLERIA PARKWAY, 15TH FLOOR, ATLANTA, GA, 30339, US

(73) Assignee: Taiwan Semiconductor Manufacturing Co., Ltd.

(21) Appl. No.: 11/454,577

(22) Filed: Jun. 16, 2006

(51) Int. Cl. B41F 1/18

(52) U.S. Cl. 101/451

(57) ABSTRACT

A direct printing lithography system for jet-printing a photoresist on a layer in the form of a desired circuit pattern is disclosed. The system includes a computer system for containing a programmed circuit pattern and generating printing signals and a jet printing head for receiving the printing signals from the computer system and printing the photoresist on the layer in the form of the programmed circuit pattern. A direct printing lithography method is also disclosed.

### FIELD OF THE INVENTION

The present invention relates to photolithography processes used in the formation of integrated circuit (IC) patterns on photoresist in the fabrication of semiconductor integrated circuits. More particularly, the present invention relates to a direct printing lithography system and method for depositing a photoresist pattern on a layer in a selected circuit pattern and etching the material layer without the need for a conventional photomask to expose and cross-link the photoresist according to the circuit pattern to be transferred to the underlying layer.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

Various processing steps are used to fabricate integrated circuits on a semiconductor wafer. These steps include deposition of a conducting layer on the silicon wafer substrate; formation of a photoresist or other mask such as titanium oxide or silicon oxide, in the form of the desired metal interconnection pattern, using standard lithographic or photolithographic techniques; subjecting the wafer substrate to a dry etching process to remove the conducting layer from the areas not covered by the mask, thereby etching the conducting layer in the form of the masked pattern on the substrate; removing or stripping the mask layer from the substrate typically using reactive plasma and chlorine gas, thereby exposing the top surface of the conductive interconnect layer; and cooling and drying the wafer substrate by applying water and nitrogen gas to the wafer substrate.

Photoresist materials are coated onto the surface of a wafer by dispensing a photoresist fluid typically on the center of the wafer as the wafer rotates at high speeds within a stationary bowl or coater cup. The coater cup catches excess fluids and particles ejected from the rotating wafer during application of the photoresist. The photoresist fluid dispensed onto the center of the wafer is spread outwardly toward the edges of the wafer by surface tension generated by the centrifugal force of the rotating wafer. This facilitates uniform application of the liquid photoresist on the entire surface of the wafer.

During the photolithography step of semiconductor production, light energy is applied through a reticle mask onto the photoresist material previously deposited on the wafer to define circuit patterns which will be etched in a subsequent processing step to define the circuits on the wafer. A reticle is a transparent plate patterned with a circuit image to be formed in the photoresist coating on the wafer. A reticle contains the circuit pattern image for only a few of the die on a wafer, such as four die, for example, and thus, must be stepped and repeated across the entire surface of the wafer. In contrast, a photomask, or mask, includes the circuit pattern image for all of the die on a wafer and requires only one exposure to transfer the circuit pattern image for all of the dies to the wafer.

The numerous processing steps outlined above are used to cumulatively apply multiple electrically conductive and insulative layers on the wafer and pattern the layers to form the circuits. The final yield of functional circuits on the wafer depends on proper application of each layer during the process steps. Proper application of those layers depends, in turn, on coating the material in a uniform spread over the surface of the wafer in an economical and efficient manner.

Spin coating of photoresist on wafers, as well as the other steps in the photolithographty process, is carried out in an automated coater/developer track system using wafer handling equipment which transport the wafers between the various photolithography operation stations, such as vapor prime resist spin coat, develop, baking and chilling stations. Robotic handling of the wafers minimizes particle generation and wafer damage. Automated wafer tracks enable various processing operations to be carried out simultaneously. Two types of automated track systems widely used in the industry are the TEL (Tokyo Electron Limited) track and the SVG (Silicon Valley Group) track.

A typical method of forming a circuit pattern on a wafer includes introducing the wafer into the automated track system and then spin-coating a photoresist layer onto the wafer. The photoresist is next cured by conducting a soft bake process. After it is cooled, the wafer is placed in an exposure apparatus, such as a stepper, which aligns the wafer with an array of die patterns etched on the typically chrome-coated quartz reticle. When properly aligned and focused, the stepper exposes a small area of the wafer, then shifts or “steps” to the next field and repeats the process until the entire wafer surface has been exposed to the die patterns on the reticle. The photoresist is exposed to light through the reticle in the circuit image pattern. Exposure of the photoresist to this image pattern cross-links and hardens the resist in the circuit pattern. After the aligning and exposing step, the wafer is exposed to post-exposure baking and then is developed and hard-baked to develop the photoresist pattern.

The circuit pattern defined by the developed and hardened photoresist is next transferred to the underlying metal conductive layer using a metal etching process, in which metal over the entire surface of the wafer and not covered by the cross-linked photoresist is etched away from the wafer with the metal under the cross-linked photoresist that defines the circuit pattern protected from the etchant. As a result, a well-defined pattern of metallic microelectronic circuits which closely approximates the cross-linked photoresist circuit pattern remains in the metal layer.

FIG. 1 illustrates a typical conventional mask photolithography process. A substrate 10 includes an oxide layer 12 deposited, thereon. A spin-on BARC (bottom anti-reflective coating) layer 14 is provided on the oxide layer 12. A photoresist layer 16 is provided on the BARC layer 14. During photolithography, UV light 26 is directed through a transparent mask 22 on which is provided an opaque chrome region 24. The transparent region of the mask 22 defines the circuit pattern to be transferred to the photoresist layer 16. Accordingly, the UV light 26 is unable to pass through the portion of the mask 22 covered by the chrome region 24, such that a shielded region 20 is formed on the photoresist layer 16. The UV light 26 does, however, pass through the transparent regions of the mask 22, forming a cross-linked exposed region 18 on the photoresist layer 16 which corresponds to the circuit pattern defined by the mask 22.

As shown in FIG. 2, subsequent development of the photoresist layer 16 in developer solution causes the cross-linked exposed region 18 of the photoresist layer 16 to remain, whereas the un-cross-linked, shielded region 20 on the photoresist layer 16 is dissolved in the developer solution. This forms a window 28 in the photoresist layer 16. Accordingly, during the subsequent etching step, the photoresist layer 16 protects underlying regions of the BARC layer 14 and oxide layer 12 such that the circuit pattern defined by the photoresist layer 16 is transferred to these underlying layers.

One of the drawbacks of conventional photolithography processes, in which a mask is used to transmit UV light to a photoresist layer in a desired circuit pattern and the photoresist is developed to remove non-cross-linked regions of the photoresist, is that the method is time-consuming and expensive. In emerging technology applications such as PCB, OLED (organic light-emitting diode), solar cell, TFT (thin film transistor)-LCD and MEMS (micro-electromechanical systems), for example, a low-cost and fast micro-patterning process is needed.

### SUMMARY OF THE INVENTION

The present invention is generally directed to a novel direct printing lithography system which utilizes a jet printing head to print a photoresist layer in a desired circuit pattern on a metal or other layer to be etched. The system includes a computer which contains the circuit patterns to be formed in the layer or layers, a signal generator for generating printing signals corresponding to a circuit pattern input signal from the computer, and a direct printing head for receiving the printing signals from the signal generator. The direct printing head includes an array of nozzle openings through which the liquid photoresist is jet-printed in the form of the desired circuit pattern onto the layer to be etched. The photoresist is exposed and then the underlying layer is etched according to the pattern defined by the cross-linked photoresist layer. Because the photoresist defines the circuit pattern as it is jet-printed onto the layer to be etched, the system eliminates the need to blanket-deposit the photoresist layer on the layer to be etched, use a photomask to expose and cross-link the photoresist according to the circuit pattern, and develop the photoresist prior to etching the layer according to the circuit pattern. This expedites and reduces the costs associated with the photolithography process.

The direct printing head may include an additional set of nozzle openings through which a liquid or gas etchant is jet-printed onto the portions of the layer not covered by the patterned photoresist to etch the layer. The direct printing head may further include a separate set of nozzle openings through which a pre-wetting solution is applied to the layer prior to dispensing the photoresist thereon. The direct printing head may also include a set of nozzle openings through which a photoresist strip chemical is applied to the photoresist after the etching step.

The present invention is further directed to a novel direct-printing micro-patterning lithography and micro-etch method for forming a circuit pattern in a layer deposited on a substrate. The method includes providing a substrate on which a metal or other layer to be etched is formed, jet-printing a photoresist layer in the form of a desired circuit pattern onto the layer to be etched, baking the photoresist, optionally exposing the photoresist layer to UV light, jet-printing an etchant onto the portions of the layer to be etched that are not covered by the photoresist layer, and stripping the photoresist layer.

The novel direct-printing micro-patterning lithography and micro-etch method of the present invention may further include providing a jet printing head having multiple pre-wetting nozzle openings, multiple photoresist-printing nozzle openings, multiple jet etching nozzle openings and multiple photoresist strip nozzle openings; positioning the jet printing head over a substrate; and sequentially jet-printing a pre-wetting solution, a liquid photoresist, an etchant and a photoresist strip chemical, respectively, through the respective sets of nozzle openings and onto each circuit exposure field on the substrate to expeditiously and efficiently etch a circuit pattern in a metal layer on the substrate.

### BRIEF DESCRIPTION OF THE DRAWINGS

The invention will now be described, by way of example, with reference to the accompanying drawings, in which:

FIGS. 1 and 2 are perspective views of a substrate with a layer to be etched deposited thereon, illustrating a conventional photolithography method for transmitting a circuit pattern from a photomask onto a photoresist layer by UV light exposure, followed by development of the photoresist;

FIG. 3 is a schematic diagram illustrating a direct printing lithography system according to the present invention;

FIG. 4 is a bottom perspective view of a jet printing head element of the system of FIG. 3;

FIG. 5 is a cross-section of a nozzle opening of the jet printing head, illustrating multiple drops of liquid photoresist being dispensed from the nozzle opening;

FIG. 6 is a perspective view of a substrate having a layer to be etched deposited thereon, illustrating jet-printing of a liquid photoresist layer in the form of a circuit pattern onto the layer to be etched according to the method of the present invention;

FIG. 7 is a perspective view of the photoresist layer deposited in the form of a circuit pattern according to the step shown in FIG. 6, illustrating jet-printing of an etchant onto the regions of the layer to be etched which are not covered by the photoresist layer;

FIGS. 8A-8D are schematic views illustrating sequential jet-printing of a pre-wetting solution, a liquid photoresist, an etchant and a photoresist chemical, respectively, onto a circuit exposure field on a substrate to form a circuit pattern in a layer on the substrate;

FIG. 9 is a flow diagram illustrating sequential process steps carried out according to a first embodiment of the method according to the present invention;

FIG. 10 is a flow diagram illustrating sequential process steps carried out according to a second embodiment of the method according to the present invention; and

FIG. 11 is a flow diagram illustrating sequential process steps carried out according to a third embodiment of the method according to the present invention.

### DETAILED DESCRIPTION OF THE INVENTION

Referring initially to FIGS. 3-5, an illustrative embodiment of the direct printing lithography system, hereinafter system, of the present invention is generally indicated by reference numeral 30 in FIG. 3. The system 30 includes a computer system 36 and a jet printing head 40 connected to the computer system 36. The computer system 36 is provided with supporting software which facilitates the storage of a circuit layout file containing various circuit layout pattern configurations to be etched in a material layer or layers on a substrate 88 by operation of the jet printing head 40, as hereinafter further described. The software enables the computer system 36 to generate and transmit printing signals 38, which correspond to a circuit pattern programmed into the computer system 36 and selected for etching into the material layer on the substrate 88, to the jet printing head 40. The printing signals 38 correspond to the circuit pattern image transmitted from the computer system 36 via the printing signals 38 and cause the jet printing head 40 to jet-print a liquid photoresist 81 (FIG. 5) onto a layer to be etched provided on the substrate 88, in the configuration of the circuit pattern. This eliminates the need to blanket-deposit a photoresist layer on the layer to be etched, expose the photoresist to UV light through a photomask or reticle, and develop the photoresist to remove the non-cross-linked regions of photoresist from the layer, since the photoresist is deposited on the layer in the configuration of the circuit pattern.

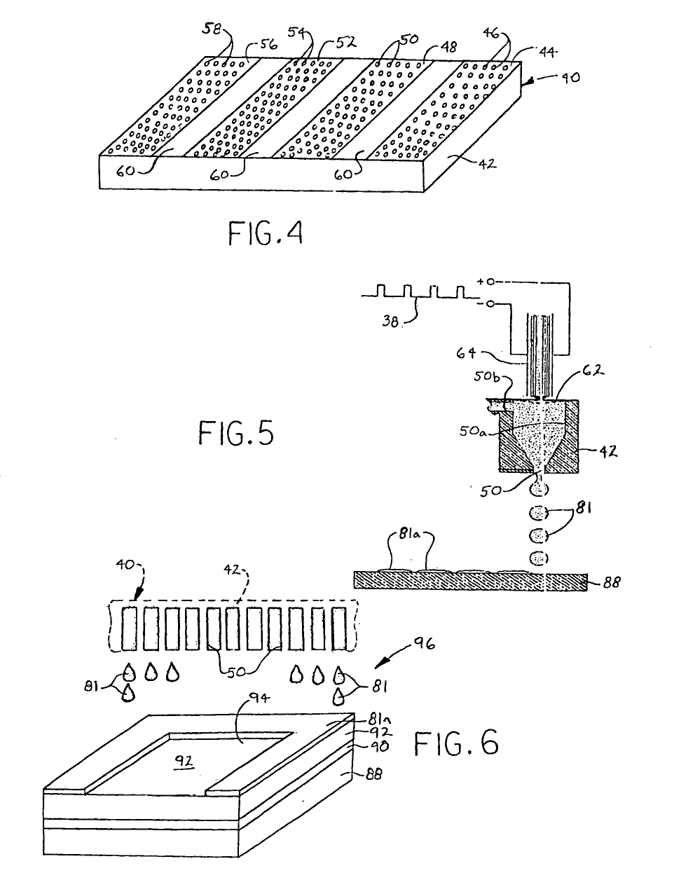

As shown in FIG. 4, the jet printing head 40 typically includes an elongated printing head body 42 which is a corrosion-resistant and etch-resistant material such as quartz, for example. The printing head body 42 may be divided into a pre-wetting section 44, provided with an array of pre-wetting nozzle openings 46; a photoresist-printing section 48, provided with an array of photoresist-printing nozzle openings 50; an etchant-printing section 52, provided with an array of etchant printing nozzle openings 54; and a photoresist strip section 56, provided with an array of photoresist strip nozzle openings 58. Heating elements 60 typically separate the adjacent pre-wetting section 44, photoresist-printing section 48, etchant-printing section 52 and photoresist strip section 56 from each other in the printing head body 42.

As shown in FIG. 3, a reservoir 76 provided on or separate from the jet printing head 40 may include a pre-wetting solution compartment 78 for containing a pre-wetting solution 79; a photoresist compartment 80 for containing a liquid photoresist 81; an etchant compartment 82 for containing a liquid or gas etchant 83; and a photoresist strip chemical compartment 84 for containing a photoresist strip chemical 85.

As shown in FIG. 5, each photoresist-printing nozzle opening 50 is typically provided at the bottom of a corresponding tapered chamber 50a having an inlet 50b that is provided in fluid communication with the photoresist compartment 80 of the reservoir 76. A flexible or deformable membrane 62 is provided in the top of each chamber 50a. A deformable piezo crystal 64 engages each membrane 62. The computer system 36 (FIG. 3) is electrically connected to the deformable piezo crystal 64 of each photoresist-printing nozzle opening 50. Accordingly, in operation of the system 30 as hereinafter further described, the computer system 36, into which is programmed the circuit pattern image to be etched in a layer on the substrate 88, generates and transmits printing signals 38, which correspond to the circuit pattern image, to the printing head 40. The printing signals 38 activate and expand the piezo crystals 64 of certain ones of the photoresist-printing nozzle openings 50. Each activated piezo crystal 64, in turn, deforms the membrane 62, causing a pressure impulse within the chamber 50a. The resulting pressure impulse expels a single droplet of photoresist 81 from the photoresist printing nozzle opening 50 onto a substrate 88. The chamber 50a is refilled with the photoresist 81 by capillary action at the nozzle opening 50. In the foregoing manner, liquid photoresist 81 is expelled from certain ones of the multiple photoresist-printing nozzle openings 50 in the photoresist-printing section 48 of the jet printing head 40 to jet-print the photoresist 81 on the substrate 88 in the form of the desired circuit pattern.

As heretofore described in FIG. 5 with respect to each photoresist-printing nozzle opening 50, each pre-wetting nozzle opening 46 in the pre-wetting section 44; each etchant-printing nozzle opening 54 in the etchant-printing section 52; and each photoresist strip nozzle opening 58 in the photoresist strip section 56 is typically also provided at the bottom of a corresponding tapered chamber 50a having an inlet 50b, a deformable membrane 62 in the top of the chamber 50a, and a deformable piezo crystal 64 engaging the membrane 62 for receiving printing signals 38 from the computer system 36. This facilitates jet-printing of the corresponding liquid from the pre-wetting solution compartment 78, etchant compartment 82 and photoresist strip chemical compartment 84, respectively, depending on the circuit pattern to be etched into the layer on the substrate 88.

Referring next to FIGS. 3, 6, 7 and 8A-8D, typical operation of the system 30 is as follows. A material layer 90, which may be an oxide or metal layer, for example, to be etched in the form of a selected circuit pattern, is deposited on a semiconductor substrate 88. A spin-on BARC (bottom anti-reflective coating) layer 92 may be blanket-deposited on the material layer 90. The portion of the material layer 90 that is to be etched in the form of a circuit pattern defines a circuit exposure field 96 on the substrate 88. Multiple exposure fields 96 are typically provided on the substrate 88, in adjacent relationship to each other, for sequential formation of the circuit pattern in each of the exposure fields 96.

The circuit pattern to be etched into the material layer 90 is initially programmed into the computer system 36. The heating elements 60 in the jet printing head 40 generate heat which prevents solidification of the photoresist 81 as it is dispensed from the jet printing head 40, as hereinafter described. As shown in FIG. 8A, the jet printing head 40 of the system 30 is positioned over the substrate 88, with the pre-wetting section 44 positioned directly over the first exposure field 96 to be processed. Depending on the circuit pattern to be etched in the material layer 90, the computer system 36 generates and transmits printing signals 38 that activate certain ones of the pre-wetting nozzle openings 46 in the pre-wetting section 44, through the piezo crystal 64 and membrane 62 (FIG. 5) of each pre-wetting nozzle opening 46, to cause the jet-printing of pre-wetting solution 79 onto the BARC layer 92, in the form of the programmed circuit pattern. In typical application, the pre-wetting solution is hexamethlydisilazane, although alternative pre-wetting solutions known by those skilled in the art may be used instead.

As shown in FIG. 8B, after pre-wetting of the exposure field 96, the jet printing head 40 is shifted to position the photoresist-printing section 48 of the jet printing head 40 over the pre-wetted exposure field 96. The computer system 36 generates and transmits printing signals 38, which correspond to a pattern forming the portions of the material layer 90 which are to be shielded and not etched to define the programmed circuit pattern, to the printing head 40. Depending on the circuit pattern programmed into the computer system 36, the printing signals 38 activate certain ones of the photoresist-printing nozzle openings 50 in the photoresist-printing section 48, through the piezo crystal 64 and membrane 62 (FIG. 5) of each. This causes the jet-printing of liquid photoresist 81 onto the BARC layer 92 in the form of the programmed circuit pattern, as shown in FIG. 6. Accordingly, photoresist 81 is not dispensed from those nozzle openings 50 which are located above the regions of the material layer 90 that are to be etched, thus forming windows 94 in those areas on the BARC layer 92.

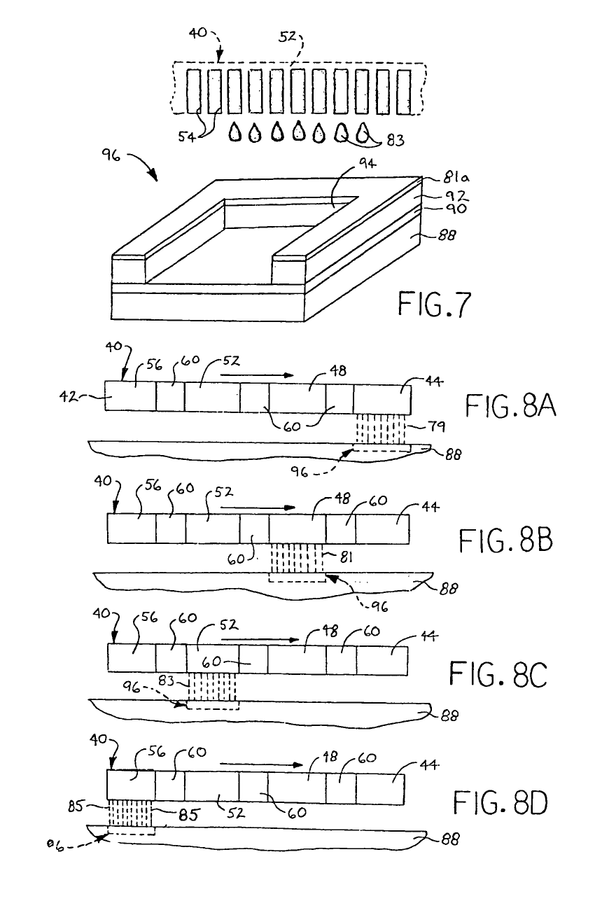

After it is dispensed onto the exposure field 96, the photoresist 81 is hard-baked to solidify the photoresist 81 in the form of the circuit pattern. As shown in FIG. 8C, the jet printing head 40 is next shifted to position the etchant-printing section 52 of the jet printing head 40 over the exposure field 96. The computer system 36 transmits printing signals 38, which correspond to those regions of the material layer 90 that are to be etched, to the printing head 40. Via the printing signals 38, the computer system 36 activates certain ones of the etchant-printing nozzle openings 54 in the etchant-printing section 52, through the piezo crystal 64 and membrane 62 (FIG. 5) of each. This causes the jet-printing of the liquid or gas etchant 83 onto the BARC layer 92 in the form of the regions of the material layer 90 which are to be etched to define the circuit pattern, as shown in FIG. 7. Accordingly, etchant 83 is not dispensed from those etchant-printing nozzle openings 54 which are located above the hardened photoresist layer 81a, thus etching those regions of the BARC layer 92 and the underlying material layer 90 that correspond to the windows 94.

As shown in FIG. 8D, after jet-printing of the etchant 83 onto the exposure field 96, the jet printing head 40 is shifted to position the photoresist strip section 56 of the jet printing head 40 over the etched exposure field 96. The computer system 36 transmits printing signals 38, which correspond to the portions of the material layer 90 covered by the photoresist layer 81a to define the programmed circuit pattern, to the jet printing head 40. The computer system 36, via the printing signals 38, activates certain ones of the photoresist strip nozzle openings 58 in the photoresist strip section 56, through the piezo crystal 64 and membrane 62 (FIG. 5) of each. This causes the jet-printing of photoresist strip chemical 85 onto the photoresist layer 81a in the form of the programmed circuit pattern. Accordingly, the photoresist layer 81a is stripped from the underlying portions of the material layer 90 which were not etched during the etching step of FIG. 8B, thus leaving the material layer 90 in the form of the desired circuit pattern.

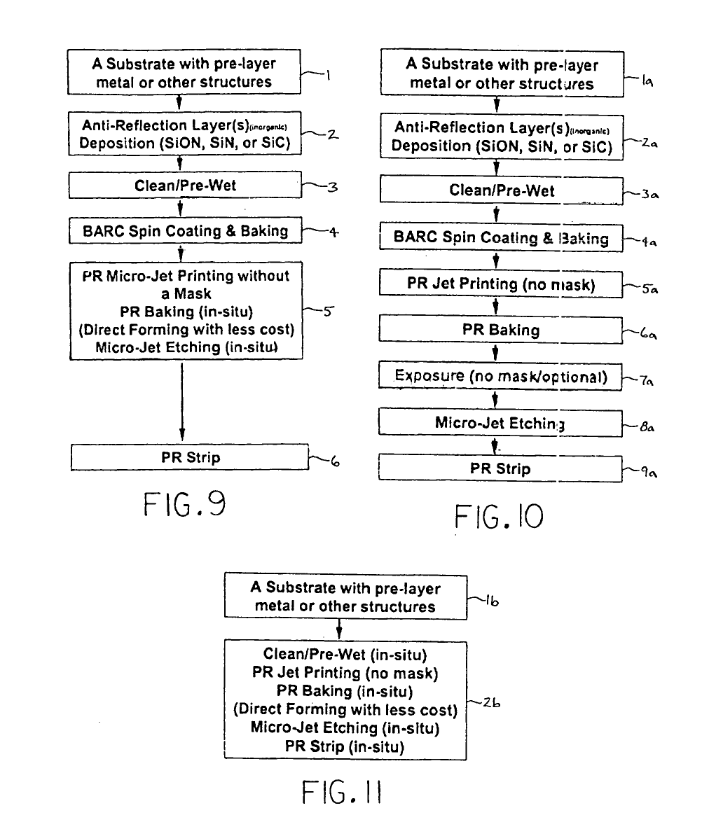

A flow diagram which illustrates sequential process steps carried out according to one embodiment of the present invention is shown in FIG. 9. In step 1, a substrate having a metal or other layer to be etched is provided. In step 2, an anti-reflection layer, such as SiON, SiN or SiC, for example, is provided on the layer to be etched. In step 3, a pre-clean or pre-wetting solution is applied to the anti-reflection layer. In step 4, a bottom anti-reflective coating (BARC) layer is spin-coated on the anti-reflection layer. In step 5, a photoresist layer is net-printed on the BARC layer, which overlies the layer to be etched. The photoresist layer is jet-printed on the BARC layer in the circuit pattern which is to be etched in the layer. The photoresist is then baked in-situ, and an etchant is applied to the BARC layer along the regions not exposed to photoresist. This etches the BARC layer and the underlying material layer in the circuit pattern. In step 6, the photoresist is stripped from the BARC layer.

A flow diagram which illustrates sequential process steps carried out according to another embodiment of the present invention is shown in FIG. 10. In step 1a, a substrate having a metal or other layer to be etched is provided. In step 2a, an anti-reflection layer, such as SiON, SiN or SiC, for example, is provided on the layer to be etched. In step 3a, a pre-clean or pre-wetting solution is applied to the anti-reflection layer. In step 4a, a bottom anti-reflective coating (BARC) layer is spin-coated on the anti-reflection layer. In step 5a, a photoresist layer is jet-printed on the BARC layer overlying the layer to be etched according to the circuit pattern which is to be etched in the layer. This step does not require the use of a mask. In step 6a, the photoresist is then baked in-situ. In step 7a, the photoresist is exposed without the use of a photomask. In step 8a, an etchant is applied to the BARC layer along the regions not exposed to photoresist to etch the BARC layer and the underlying material layer according to the desired circuit pattern. In step 9a, the photoresist is stripped from the BARC layer.

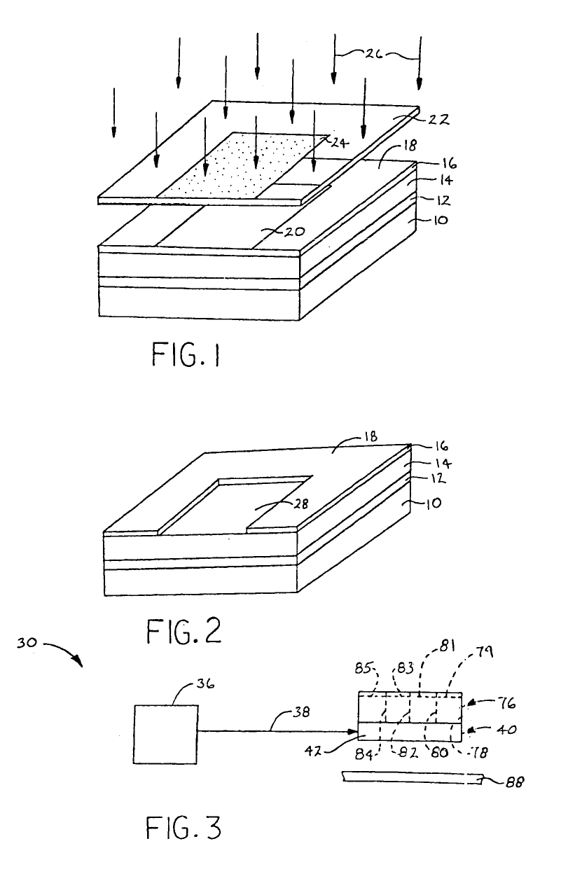

FIG. 11 illustrates sequential process steps carried out according to yet another embodiment of the present invention. In FIG. 1b, a substrate having a metal or other layer to be etched is provided. In step 2b, various process steps are sequentially carried out on each of multiple exposure fields on the substrate. These sequential process steps include pre-wetting or pre-cleaning the layer to be etched; jet-printing a photoresist layer on the layer to be etched, according to a desired circuit pattern; baking of the photoresist; etching the layer according to the desired circuit pattern by jet-printing an etchant on the layer to be etched along the regions of the layer not covered by the photoresist; and stripping the photoresist from the layer, respectively.

While the preferred embodiments of the invention have been described above, it will be recognized and understood that various modifications can be made in the invention and the appended claims are intended to cover all such modifications which may fall within the spirit and scope of the invention.

What is claimed is:

1. A direct printing lithography system for printing a photoresist on a layer, comprising:
a computer system for containing a programmed circuit pattern and generating printing signals; and
a jet printing head connected to said computer system for receiving the printing signals from said computer system and printing the photoresist on the layer in the form of the programmed circuit pattern.

2. The system of claim 1 wherein said jet printing head and a plurality of pre-wetting nozzle openings for dispensing pre-wetting solution from said jet printing head.

3. The system of claim 1 wherein said jet printing head comprises a plurality of photoresist-printing nozzle openings for dispensing the photoresist from said jet printing head and a plurality of etchant-printing nozzle openings for dispensing etchant from said jet printing head.

4. The system of claim 1 wherein said jet printing head comprises a plurality of photoresist-printing nozzle openings for dispensing the photoresist from said jet printing head and a plurality of photoresist strip nozzle openings for dispensing a photoresist strip chemical from said jet printing head.

5. The system of claim 1 further comprising at least one heating element provided in said jet printing head for heating the photoresist.

6. The system of claim 1 wherein said jet printing head comprises an elongated printing head body comprising a plurality of photoresist printing nozzle openings for dispensing the photoresist onto the layer and a plurality of etchant-printing openings for dispensing an etchant onto the layer.

7. The system of claim 6 further comprising a plurality of pre-wetting nozzle openings provided in said printing head body for dispensing a pre-wetting solution onto the layer.

8. The system of claim 7 further comprising a plurality of photoresist strip nozzle openings provided in said jet printing head for dispensing a pre-wetting solution onto the layer.

9. A method for printing a photoresist layer on a layer provided on a substrate, comprising:
providing a substrate;
providing a layer to be etched according to a circuit pattern on said substrate;
providing a photoresist; and
printing a photoresist layer on said layer to be etched in a form of said circuit pattern by dispensing said photoresist on said layer to be etched.

10. The method of claim 9 further comprising printing a pre-wetting solution on said layer to be etched prior to said printing a photoresist layer.

11. The method of claim 9 further comprising etching said layer to be etched by printing an etchant on said layer to be etched after said printing a photoresist layer.

12. The method of claim 11 further comprising printing a photoresist strip chemical on said photoresist layer after said etching said layer to be etched.

13. The method of claim 12 further comprising printing a pre-wetting solution on said layer to be etched prior to said printing a photoresist layer.

14. The method of claim 9 further comprising heating said photoresist prior to said dispensing said photoresist on said layer to be etched.

15. The method of claim 14 further comprising etching said layer to be etched by providing an etchant, heating said etchant and printing said etchant on said layer to be etched after said printing a photoresist layer.

16. The method of claim 15 further comprising providing a pre-wetting solution, heating said pre-wetting solution and printing said pre-wetting solution on said layer to be etched prior to said printing a photoresist layer; and providing a photoresist strip chemical, heating said photoresist strip chemical and printing said photoresist strip chemical on said photoresist layer after said etching said layer to be etched.

17. A direct printing lithography system for printing a photoresist on a layer, comprising:
a computer system for containing a programmed circuit pattern and generating printing signals; and
a jet printing head connected to said computer system for receiving the printing signals from said computer system and printing the photoresist on the layer in the form of the programmed circuit pattern, said jet printing head comprises a plurality of photoresist-printing nozzle openings for dispensing the photoresist from said jet printing head and a plurality of pre-wetting nozzle openings for dispensing pre-wetting solution from said jet printing head.

18. The system of claim 17 further comprising a plurality of etchant-printing nozzle openings for dispensing etchant from said jet printing head.

19. The system of claim 17 further comprising a plurality of photoresist strip nozzle openings for dispensing a photoresist strip chemical from said jet printing head.

20. The system of claim 17 further comprising at least one heating element provided in said jet printing head for heating the photoresist.
